(19) United States
(12) Patent Application Publication
(10) Pub. No.: US 2007/0033144 A1
(43) Pub. Date: Feb. 8, 2007

(54) Binding components

(75) Inventors: Matthew Howard, Redmond, WA (US); Gurpratap Virdi, Bellevue, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/196,072

(22) Filed: Aug. 3, 2005

(51) Int. Cl. G06F 17/60

(52) U.S. Cl. 705/55

(57) ABSTRACT

Various embodiments permit access to a software component's functionality to be limited. In at least some embodiments, access to some or all of a component's functionality can be limited through the use of a validation identifier that is used as a means to validate another entity wishing to access the limited functionality or bind that entity to the particular component.

### BACKGROUND

Many software components perform multiple functions. In some circumstances, it would be desirable to limit access to some or all of the functions that these components perform.

### SUMMARY

Various embodiments permit access to a software component's functionality to be limited. In at least some embodiments, access to some or all of a component's functionality can be limited through the use of a validation identifier that is used as a means to validate another entity wishing to access the limited functionality or bind that entity to the particular component. For example, an application can be provided with a validation identifier that is shared with the component having limited access. When the application wishes to access the limited functionality, the application can provide the validation identifier which can then be used to validate that the application can access the functionality.

### BRIEF DESCRIPTION OF THE DRAWINGS

FIG. 1 is a block diagram that illustrates some high level concepts in accordance with one or more embodiments.

FIG. 2 is a block diagram that illustrates concepts associated with one or more embodiments.

FIG. 3 is a block diagram that illustrates but one specific implementation that utilizes concepts described in connection with FIGS. 1 and 2.

### DETAILED DESCRIPTION

Overview

Various embodiments permit access to a software component's functionality to be limited. In at least some embodiments, access to some or all of a component's functionality can be limited through the use of a validation identifier that is used as a means to validate another entity wishing to access the limited functionality or bind that entity to the particular component. For example, an application can be provided with a validation identifier that is shared with the component having limited access. When the application wishes to access the limited functionality, the application can provide the validation identifier which can then be used to validate that the application can access the functionality.

In the discussion that follows, a section entitled “Exemplary Embodiment” is provided and describes various aspects associated with various inventive embodiments. Following this, a section entitled “Implementation Example” is provided to illustrate but one exemplary context in which the inventive embodiments can be employed.

### EXEMPLARY EMBODIMENT

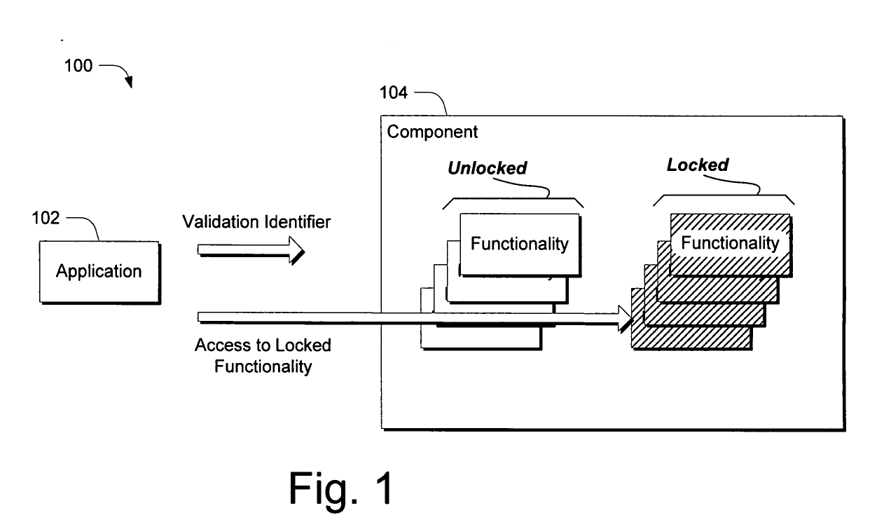

FIG. 1 illustrates an exemplary system, generally at 100, that includes an application 100 and a component 104. Typically, system 100 can be implemented in software in the form of computer-readable instructions that reside on some type of computer-readable media.

In this example, component 104 embodies a collection of functionality, some of which is locked down (as indicated by the crosshatching) and others of which is not locked down. It is to be appreciated and understood that all of the functionality of component 104 could be locked down.

In this example, application 102 may desire to use some of the locked down functionality embodied by component 104. In this case, applications that are authorized or otherwise allowed to use such functionality can be provided with a validation identifier. Any suitable criteria can be used to determine whether an application is authorized or otherwise allowed to use the locked-down functionality. For example, external license agreements between providers of component 104 and application 102 may limit access to certain functionality based upon the type or origin of the application seeking access. Other criteria can be used without departing from the spirit and scope of the claimed subject matter.

Any suitable validation identifier can be utilized. In but one embodiment, the validation identifier can assume the form of a globally unique identifier or GUID. Accordingly, when the application wishes to access the locked-down functionality, it can call component 104, either directly or indirectly, and provide the validation identifier. The validation identifier can then be used to validate that access to the locked down functionality should be provided to the application.

In this particular example, the application and component 104 share a common validation identifier. Accordingly, when the application calls the component for validation and provides the validation identifier, the component performs a check to ascertain whether the identifiers match and, if so, allows access to the locked-down functionality.

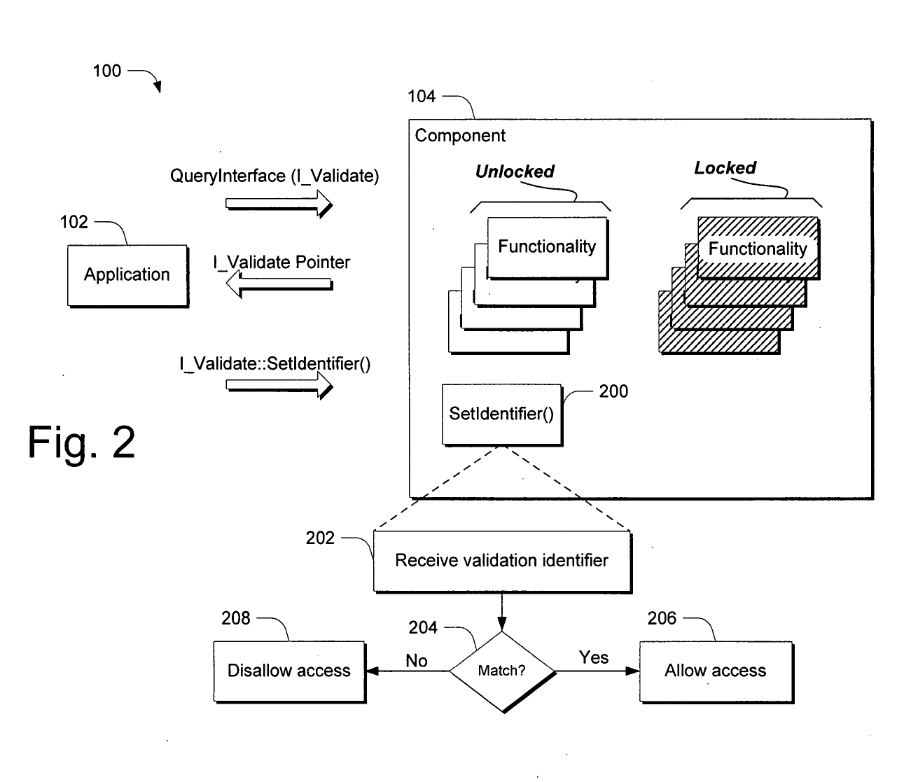

FIG. 2 illustrates the system of FIG. 1 in the context of one implementation example. In this example, application 102 desires to utilize at least some of the locked down functionality embodied by component 104. As such, the application makes a call on component 104 to ascertain whether the component supports a particular interface whose presence implies that the component has functionality that is locked down. In the FIG. 2 example, this call is the “QueryInterface (I_Validate)” call which effectively asks component 104 whether it supports the I_Validate interface.

In the event component 104 does support the interface of interest, the component returns a pointer to that interface back to the application. In the illustration, this is represented as a return arrow bearing the caption “I_Validate Pointer”.

Having a pointer to the I_Validate interface, application 102 now calls the interface's Setldentifier( ) method 200 and passes in the validation identification that is to be used in the validation process.

Accordingly, the component's implementation of the SetIdentifier( ) method receives, at step 202, the validation identifier provided by the application. At step 204, the component checks to ascertain whether the validation identifier it received from the application matches with the validation identifier that it contains. If there is a match, then step 206 allows access to the locked-down functionality or some subset of the functionality. If, on the other hand, step 204 determines that there is not a match, step 208 disallows access to the locked-down functionality.

Accordingly, in the above example, the functionality that is locked down by component 104 can be accessed by an application through a series of calls that first ascertain whether a particular interface is supported by the component. In the event the interface is supported (implying that some functionality is locked down), the application can then call the interface to provide the appropriate validation identification.

It is to be appreciated and understood that the above-described techniques can be utilized in any suitable context or environment in which it is desirable to lock down some or all of a component's functionality. As but one example of an environment in which the inventive techniques can be employed, consider the discussion under the heading “Implementation Example” just below.

### IMPLEMENTATION EXAMPLE

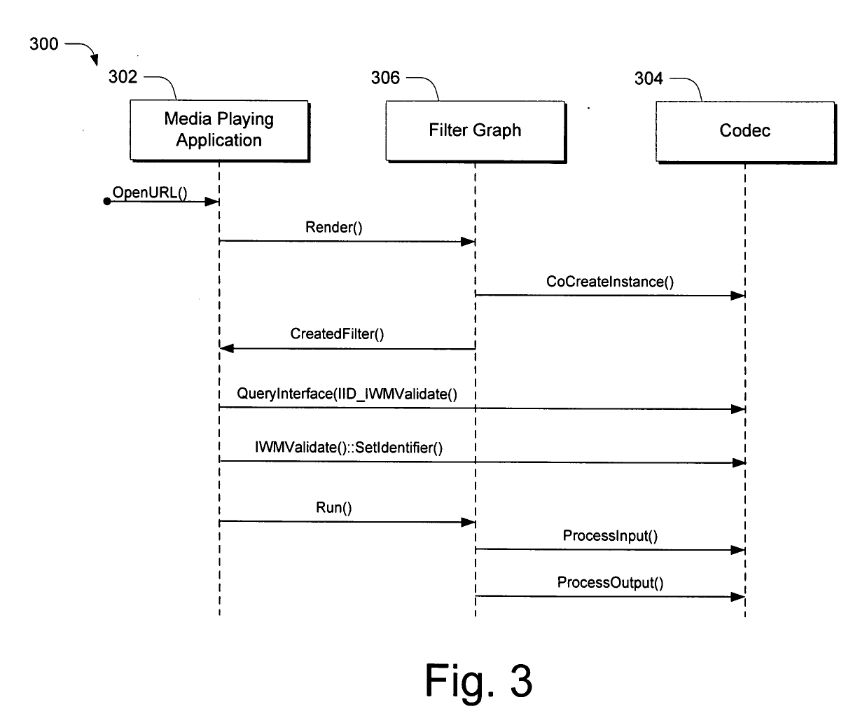

FIG. 3 shows an exemplary system in which the inventive principles described above can be utilized, generally at 300. In this system, an application 302 takes the form of a media playing application such as, for example, Microsoft's Windows® Media Player. Other types of applications can, however, be employed without departing from the spirit and scope of the claimed subject matter.

In addition, a component 304 in the form of a coder-decoder (codec) is provided and includes functionality that is locked down and initially inaccessible to various applications. Typically, codec 304 performs a number of different functions among which include compressing uncompressed media data and uncompressing compressed media data. In the present example, consider that the functionality that is locked down is the compression/decompression functionality. In this particular example, the codec 304 is implemented as a DirectX Media Object or DMO.

A DMO is a COM object that transforms data. Data is passed into the DMO, the DMO transforms the data and then returns the transformed data. In the case of a codec encoder DMO, uncompressed media data is provided to it, and the DMO delivers compressed media data. Likewise, in the case of the codec decoder DMO, compressed media data is provided to it, and the DMO delivers decompressed media data. One advantage of a DMO is that they all implement the same base interface which simplifies working with the DMO. Specifically, one can use the same object, regardless of the type of transformation being performed.

In general, information that is utilized by codec DMOs to compress and decompress digital media is conveyed in one of three ways: (1) the input type is set on the DMO to convey the characteristics of the uncompressed media that is passed to an encoder DMO, and the characteristics of the compressed media that is passed to a decoder DMO; (2) the output type is set on the DMO to convey the characteristics of the compressed media that are delivered by an encoder DMO, and the characteristics of the uncompressed media that are delivered by a decoder DMO; and methods of an interface, such as the IPropertyBag interface, are used to configure other settings that support the various features of the codec DMOs as properties.

Input and output types are specific to input and output streams. Each stream represents a discrete representation of the content. For example, the Windows Media Video encoder DMO has a single input stream, and two output streams. The input stream accepts uncompressed video samples. The first of the two output streams delivers compressed samples; the other provides uncompressed samples. The individual samples in one output stream represent the same content as the corresponding samples in the other stream, but each stream delivers those samples in a different format.

Each stream (input or output) supports one or more types of media. A media type, or format, is described by a particular type of data structure. The DMO can be queried for the types that are supported by an output stream.

When the output and input types for the DMO have been set, the DMO can begin processing samples. Each input sample is passed to the codec using a method call to process the input, and each output sample is delivered by the codec when a call is made to a method to process the output.

Further, in this particular system a multi-media pipeline in the form of a filter graph 306 is provided and, together with the other components, processes media content such as audio and video samples so that the samples can be rendered in some particular way, such as to a display monitor or written to disk. More generally, however, filter graph 306 can be thought of as a type of Software Development Kit or SDK that contains objects that perform tasks associated with the creation, editing and/or playback of multimedia content, as will be appreciated by the skilled artisan.

Consider now that it is desirable to bind, in a sense, component 304 to application 302 so that only application 302 can access and utilize some or all of the functionality that is embodied by component 304. In this particular example, the functionality that is desired to be bound is the compression/decompression functionality. In order to bind component 304 to application 302 in this example, a validation identifier in the form of a GUID is used. These two components share the GUID which is known only to them. Of course, other applications that are permitted access might, for example, share the same GUID or a different GUID with component 304.

In this example, after instantiating the DMO, but before using it to process data, application 302 first uses the GUID to identify itself to the DMO. One exemplary process flow of how the validation process can work is shown in FIG. 3 and described just below.

Preliminarily, in the multimedia processing context, media player application 302 is called via OpenURL( ) to open or otherwise access particular media content that is desired to be rendered. Application 302 then calls a Render( ) method on filter graph 306 to begin the process of rendering the multimedia content including, setting up and configuring the filter graph through, for example, a filter graph manager.

The filter graph manager then creates an instance of the particular DMO that is going to be utilized by calling CoCreateInstance( ), and then informs the application 302 that the DMO has been created through the CreatedFilter( ) call back to the application.

When the DMO 304 is created, it makes available a base interface to the application which, in this example, is called IBaseFilter interface. Application 302 then queries the IBaseFilter interface for a new interface IWMValidate via QueryInterface(IID_IWMValidate( )). If the DMO 304 exposes the IWMValidate interface, this implies that at least a subset of functionality that is embodied by the component is restricted or locked down. Responsive to exposing the IWMValidate interface, application 302 uses a method—here IWMValidate::Setldentifier( ) to pass the DMO the shared GUID.

The DMO's implementation of the IWMValidate::Setldentifier( ) method checks to make sure that the caller indeed shares the GUID. If the identifier is correct, then the DMO will be unlocked and allow the application to use it to process data. Otherwise, the DMO will refuse to process data.

The application then uses DMO 304 as part of the filter graph 306 to process and render content, as will be appreciated by the skilled artisan. This is represented in the illustration as Run( ) calls made to the filter graph 306, and ProcessInput( ) and ProcessOutput( ) calls made to the codec 304.

### CONCLUSION

Various embodiments described above permit access to a software component's functionality to be limited. In at least some embodiments, access to some or all of a component's functionality can be limited through the use of a validation identifier that is used as a means to validate another entity wishing to access the limited functionality. For example, an application can be provided with a validation identifier that is shared with the component having limited access. When the application wishes to access the limited functionality, the application can provide the validation identifier which can then be used to validate that the application can access the functionality.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A computer-implemented method comprising:
ascertaining whether a component having locked-down functionality supports a particular interface;
in an event the component supports the interface, calling the interface, with an application, to provide a validation identifier that can be utilized by the component to ascertain whether the application should be allowed access to the locked-down functionality; and
in an event the validation identifier matches with a validation identifier shared by the component, accessing the locked down functionality.

2. The method of claim 1, wherein said acts of ascertaining, calling and accessing are performed by a media player application.

3. The method of claim 1, wherein said act of ascertaining is performed by calling a component that is configured to process multimedia content as part of a multimedia pipeline.

4. The method of claim 1, wherein said act of ascertaining is performed by calling a component comprising a codec.

5. One or more computer-readable media having computer-readable instructions thereon which, when executed, implement the method of claim 1.

6. A computer-implemented method comprising:
receiving a call from an application that contains a validation identifier that is to be used to ascertain whether the application should be allowed to access locked-down functionality;
ascertaining whether the validation identifier matches with a shared validation identifier; and
in an event of a match between the validation identifier and the shared validation identifier, allowing access to the locked-down functionality.

7. The method of claim 6 further comprising prior to receiving said call, receiving a call from the application to ascertain whether a particular interface is supported, wherein if said particular interface is supported, said call that contains a validation identifier is made to said particular interface.

8. The method of claim 6, wherein said act of receiving is performed by receiving a call to a method, wherein said method performs said act of ascertaining.

9. The method of claim 6, wherein said acts of receiving, ascertaining and allowing are performed by a component that is configured to process multimedia.

10. The method of claim 6, wherein said acts of receiving, ascertaining and allowing are performed by a codec component that is configured to process multimedia.

11. One or more computer-readable media having computer-readable instructions thereon which, when executed, implement the method of claim 6.

12. A computer-implemented method comprising:
locking down functionality associated with a codec component that is to be used as part of a multimedia processing pipeline; and
binding one or more software entities to the codec component through the use of a shared validation identifier, wherein said binding allows only entities that share said validation identifier to access locked-down functionality.

13. The method of claim 12, wherein the act of locking down is performed by locking down the codec's compression/decompression functionality.

14. The method of claim 12, wherein said codec is implemented as a DirectX Media Object (DMO).

15. The method of claim 12 further comprising after instantiating the codec component, receiving a call with the codec component, from an entity, to ascertain whether the codec component supports a first interface.

16. The method of claim 15 further comprising receiving a call, from said entity, to a method supported by said first interface and which provides a validation identifier.

17. The method of claim 16 further comprising using the validation identifier to validate said entity and provide access to said locked-down functionality.

18. The method of claim 16 further comprising receiving, with said codec component, one or more calls that utilize said locked-down functionality.

19. The method of claim 12, wherein at least one of said software entities comprises a media playing application.

20. One or more computer-readable media having computer-readable instructions thereon which, when executed, implement the method of claim 12.
